(19) United States
(12) Patent Application Publication
(10) Pub. No.: US 2015/0158172 A1
(43) Pub. Date: Jun. 11, 2015

(54) Tool Container

(71) Applicants: Marc Clifford CONWAY, Waikiki, Western Australia (AU); Adam Lyndsay THOMAS, Coverty, Queenland (AU)

(72) Inventors: Marc Clifford Conway, Waikiki (AU); Adam Lyndsay Thomas, Coverty (AU)

(73) Assignee: AT & MC Pty Ltd, Waikiki (AU)

(21) Appl. No.: 14/390,183

(22) PCT Filed: Apr. 4, 2013
(86) PCT No.: PCT/AU2013/000345

§ 371 Date: Oct. 2, 2014

(30) Foreign Application Priority Data
Apr. 4, 2012 (AU) 201290611

(51) Int. Cl. B25H 3/02; B65D 43/22; B65D 6/34; B65D 25/10; B65D 25/22

(52) U.S. Cl. CPC B25H 3/02; B65D 25/10; B65D 25/22; B65D 7/44; B65D 43/22

(57) ABSTRACT

A tool container (10,100) has a body portion (12,102) and a hinged lid (14,104). The lid can include an integral or moulded handle (108). The body portion can include an internal supporting frame (120) attached within and to the inside of the body. The frame can be made of metal and the body of a moulded plastic. External carrying/lifting points (114,118) are provided. Double action hooks (116) can be used to attach the container to an EWP or other raised platform. The container can also be lifted by crane for safe, inaccessible storage off the ground. The rear face (110) of the container can be curved for comfortable transport on a person's back.

### FIELD OF THE INVENTION

The present invention relates to a tool container, such as for workman/tradesman tools or medical equipment.

### BACKGROUND TO THE INVENTION

Working from elevated platforms is challenging. There is typically little floor space provided by the platform, and tools are typically stored in a. bin-like container that takes up at least a portion of the already limited floor space.

Further, workers using the elevated platform will typically be required to bend down to retrieve or return tools when required, leading to associated occupational health and safety risks.

US 2010/0108684 to William Karl Talbott discloses an article holding device for an elevated work platform. The article holding device has two compartments with a channel therebetween. A bracing member extends between horizontal bars of the work platform to brace and hold the article holding device to the upper bar. Such a device requires the bracing member in order to attach the device to the elevated work platform, and does not provide lifting facility to move or secure the device. Furthermore, articles placed in the compartments are not secured and are not protected by a lid.

US 2006/0021985 discloses a storage receptacle for suspension from a horizontal support, such as a rail of a elevated work platform (EWP). A lid covers the opening to the storage receptacle and rear hanging brackets are used to hang the receptacle on the horizontal rail. However, no lifting or transport facility is provided, such as lifting rings for moving or securing the receptacle at height. Also, no handle is provided on the lid for transport/moving the receptacle or for opening the lid.

U.S. Pat. No. 6,467,577 discloses a tool box with a lid incorporating a hook portion such that, when the lid is opened, the hooked portion enables the tool box to be attached and thereby suspended from the top rung of a ladder.

U.S. Pat. No. 6,892,858 discloses a braced tool bag with a clip for hanging the bag from a rung of ladder or from scaffolding etc.

None of the aforementioned known art provides advantages that one or more embodiments of the present invention can provide, such as an internal support structure or frame, an impact resistant shell, lifting/transport means and secure and safe attachment means to meet modern safety and operating conditions and requirements.

### SUMMARY OF THE INVENTION

In accordance with a first aspect of the present invention, there is provided a tool container comprising: at least one tool receiving portion arranged for receiving a tool; and a rail engaging portion arranged so as to be releasably engageable with a rail.

The tool container may comprise a plurality of compartments and/or tool holders for receiving respective tools.

In an embodiment, the rail engaging portion is arranged so as to be releasably engagable with a rail of an elevating work platform (EWP).

A tool container having a rail engaging portion that is releasably engagable with a rail of an EWP provides a number of significant advantages. For example, the tool container can be mounted above a floor of the EWP such that a worker need not bend over to retrieve or replace a tool or other piece of work equipment or personal item. Such placement provides benefits in respect of occupational health and safety aspects.

The tool container may be arranged to be moveable between an open configuration for facilitating receiving items within an internal portion of the tool container and removing items from the internal portion1 and a closed position for preventing removal of items from the internal portion.

In an embodiment, the tool container is arranged such that the rail engaging portion is releasably engagable with the rail when the tool container is in the open configuration. For example, the rail engaging portion may be located on an inner surface of a closable lid portion such that the rail engaging portion is exposed and able to be engaged with the rail when the lid portion is open.

By providing a tool container that is arranged such that the rail engaging portion is releasably engagable with the rail when the tool container is in the open configuration, the rail engaging portion is not exposed when the tool container is in the closed configuration, thereby reducing a size of the tool container when the tool container is in the closed configuration, and improving a safety aspect of the tool container as the rail engaging portion will not be exposed, for example, when the tool container is being carried when in the closed configuration.

The lid portion may be coupled to a body portion of the tool container by at least one hinge. In one embodiment, the hinge is a piano hinge. The hinge may be configured so as to support the tool container, such as when the tool container is loaded with tools. Alternatively multiple hinges spaced apart and connecting the lid portion to the body portion may be utilised.

The tool container may comprise at least one tool holder. The at least one tool holder may be arranged within the tool receiving portion or on an external surface of the tool container. In one embodiment, the tool container comprises a plurality of tool holders, at least one tool holder being arranged within the tool receiving portion and a further tool holder being arranged on the external surface of the tool containers.

The at least one tool holder may be arranged to receive a particular type of tool or tools or tools designed for a particular purpose or application. For example, medical equipment for paramedic or emergency applications. Thus, the tool container may be customised to a particular need or application.

The tool container may comprise at least one job lock key holder for holding a job lock key that is used for locking a function, such as a movement operation, of an EWP, a hoist, a crane or similar equipment in respect of a particular job.

The tool container may comprise a sleeve for receiving job tags or similar.

The tool container may comprise a portion for receiving personal items. In one embodiment, the portion for receiving personal items is a pouch, the pouch being located within the tool receiving portion of the tool container.

In one embodiment, the tool container can be retained in a closed configuration.

In one example, the tool container comprises a closable lid portion and a lid receiving portion, the lid portion and the lid receiving portion being arranged such that the lid portion can be retained in the closed position. The lid portion and/or the lid receiving portion may be arranged such that the tool container is lockable in the closed configuration.

In one embodiment, the lid portion comprises an aperture or receiving a latch hole of the tool container. The latch hole may be arranged o as to receive a padlock or similar. The aperture and/or the latch hole may be reinforced, or example reinforced with metal such as steel or aluminium.

In one embodiment, the lid portion is arranged so as to overlap at least a portion of the tool receiving portion when the lid portion is in the closed configuration.

Providing a lid portion that is arranged to overlap the at least a portion of the tool receiving portion may assist in providing protection from weather and/or theft.

The container may comprise at least one carrying portion for facilitating lifting of the container. The at least one carrying portion may be arranged so as to facilitate lifting of the container by a crane or similar. In one embodiment, the carrying portion comprises at least one ring member. The at least one ring member may be a D-ring or similar.

In another embodiment, the carrying portion may include or be attached to one or more carrying hooks, such as double action scaffold hooks. Thus, a hoop or ring attached to a respective portion of the container body may also be connected in turn to a carrying hook that is used to lift the container to an elevated position for use at height or for security/safety storage of the container when it is not in use. Use of double action hooks provides added security of connection of the hooks for lifting/carrying purposes whilst allowing a user one handed operation to release/apply each hook.

The at least one carrying portion, or a further carrying portion, may be arranged so as to facilitate lifting of the container by a user. In one example the at least one carrying portion is arranged to facilitate lifting of the container on a back of the user. In one embodiment, the carrying portion comprises at least one strap arranged such that the user can carry the tool container in a manner similar to a backpack. In one embodiment, the carrying portion comprises two shoulder straps. The shoulder straps may be coupleable to one another by a further strap, such as a chest strap.

For embodiments wherein the container comprises a lid that is closable over at least one of the tool receiving portions, the at least one carrying portion may be arranged such that the at least one carrying portion does not interfere with closure of the lid.

The tool container may comprise padding or providing comfort to a user when the tool container is carried on the user's back. The padding may be arranged at a lower region of the tool container. The padding may be adjustable.

The container may be arranged to support at least a portion of user's weight, for example when a user sits on the container. In one embodiment, the container comprises a substantially rigid frame that is configured so as to support at least a portion of the user's weight.

The container may comprise a reinforcing structure formed from a first material, such as metal such as steel or aluminium, and a body comprising a second material, such as a polymer.

In embodiments wherein the container comprises a lid, the lid may be formed from a material that is capable of supporting at least a portion of the user's weight.

For example, the lid may be formed from an appropriate material such as a metal such as steel or aluminium or a suitable polymer.

The reinforcing structure may comprise at least one support bar that extends from a lower end of the tool container to an upper end of the tool container.

In one embodiment, the at least one support bar is coupled to the at least one ring member. The reinforcing structure may comprise upper and/or lower support portions, the support portions extending along a perimeter of the tool container.

The lid portion may include a handle, which is preferably moulded into a polymer material forming the lid, such as ABS plastic, polypropylene, polycarbonate or PVC. Alternatively the handle can be a discrete member separately attached to the lid portion, such as a polymer or metal handle riveted to a polymer or metal lid portion.

It will be noted that at least one embodiment has a curved shape to the rear face of the body portion. The curved form provides additional comfort to a person carrying the tool container on their back. Padding can be provided on shoulder straps (not shown) and applied to the rear face.

Releasable clasps can be used to retain the lid portion closed. Release of the clasps allows the lid portion to be hingedly opened for access into the body portion of the container.

Rings may be provided at respective sides of the container body. The rings project from the body portion and provide for attachment of lifting/carrying hooks. The lifting/carrying hooks can be double action scaffold hooks.

An internal support structure may be provided within the container body. This may be provided in the form of a frame comprising a lower strap or straps attached to an upper band or bands around the inside of the upper portion of the container body.

Preferably the lower strap(s) and upper band(s) are attached together where the rings are provided. Thus, the attachment of the rings to/through the body of the container can be used to also connect the lower strap and upper band together, such as by riveting. This allows the upper band(s) and lower strap(s) to be manufactured as discrete parts then subsequently joined to form the frame.

Rings may be provided attached to the upper portion of the upper band(s). These rings can be used as alternative or additional lifting points, and can be used to secure the container to a EWP or other raised platform etc.

The lower strap(s) and upper band(s) may be slotted or have other holes therethrough or attachment points for attachment of the support structure to the inside of the container body. For example, rivets, screws or bolts may be used to connect through the material of the wall9s) of the container body into the slots and thereby connect the support structure and body together.

The hinges and clasps may be mounted to the support structure for added strength and integrity of the tool container.

Preferably the support structure is formed of stainless steel, though mild steel or aluminium can be used in lower strength applications.

### BRIEF DESCRIPTION OF THE DRAWINGS

In order that the present invention may be more clearly ascertained, embodiments of the present invention will now be described, by way of example only, with reference to the accompanying drawings, in which:

FIG. 1 is a side view of a tool container in accordance with an embodiment of the present invention;

FIG. 2 is a top view of the tool container of FIG. 1, the tool container being in an open configuration; and

FIG. 3 is a partial front cross section view of the tool container of FIG. 1 showing the tool container coupled to a chain for lifting the tool container.

FIGS. 4a to 4d show various views of a tool container according to an alternative embodiment of the present invention.

FIGS. 5a to 5d show various views of an internal support structure of the tool container according to an embodiment of the present invention.

### DESCRIPTION OF PREFERRED EMBODIMENT

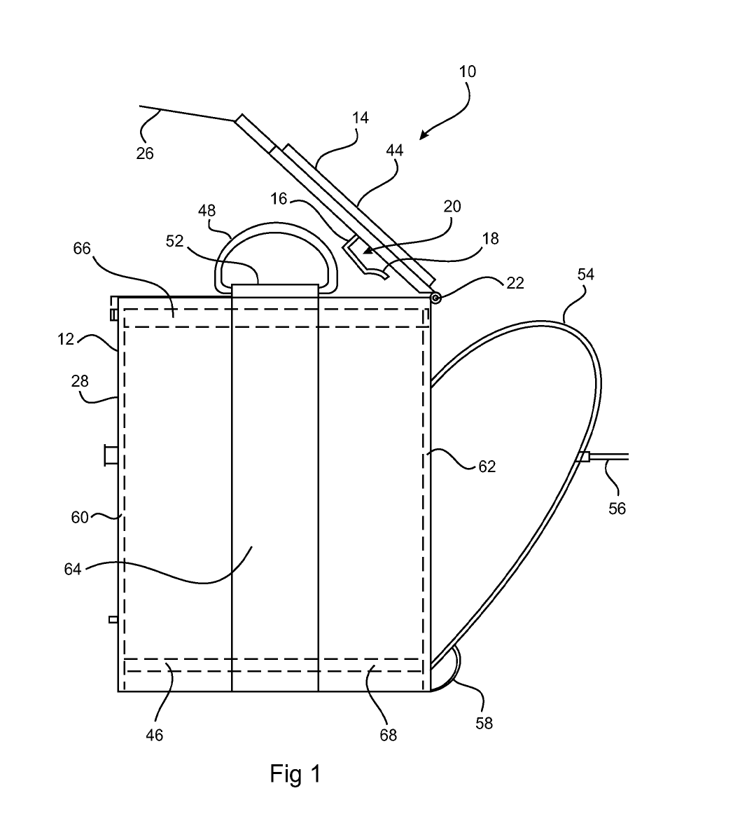

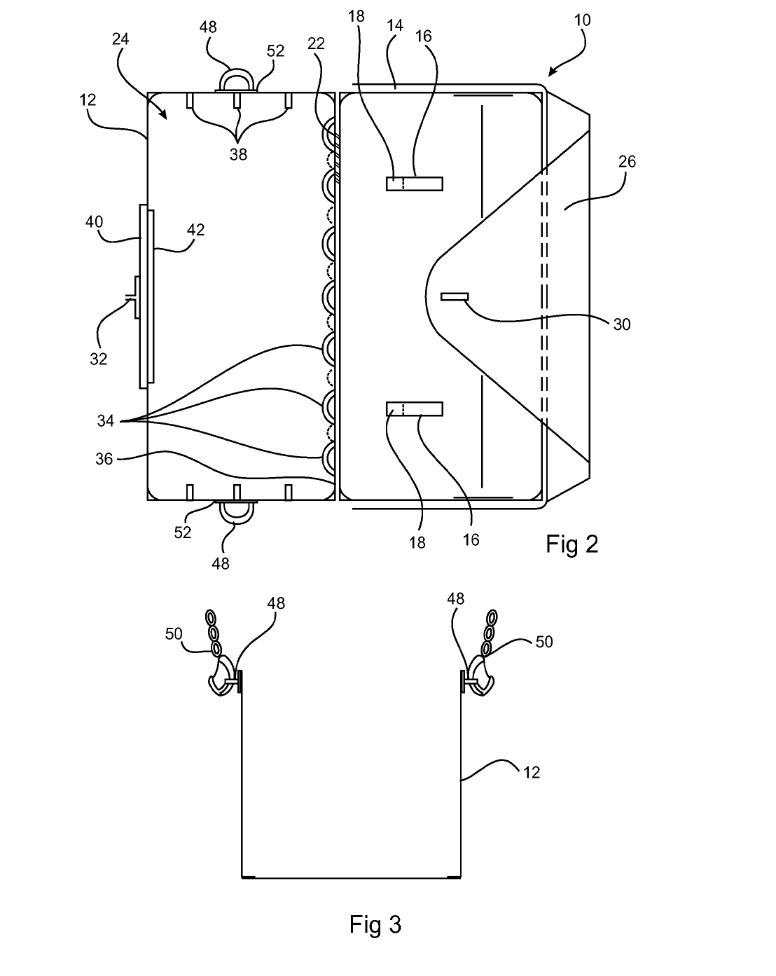

In general, there is provided a tool container 10, an example of which is illustrated in FIG. 1. The tool container 10 is arranged to receive tools, such as tools that may be used by a construction worker or similar. The tools can be received in respective compartments and/or respective tool holders, such as tool frogs. The tool container is arranged so as to be releasably engagable with a rail, such as a rail of an elevating work platform (EWP).

The tool container 10 provides a number of advantages by virtue of its arrangement whereby the tool container 10 is releasably engagable with a rail. For example, in the case wherein the tool container 10 is releasably engagable with a rail of an EWP, the tool container 10 can be mounted above a floor of the EWP such that a worker need not bend over to retrieve or replace a tool or other piece of work equipment or personal item. Such placement provides obvious benefits in respect of occupational health and safety aspects.

The tool container can advantageously be employed in rapid/fast/emergency response scenarios where equipment/tools/medical supplies need to be provided quickly at height or lowered to difficult to access locations. The tool container is robust, and preferably has an internal support structure connected directly to the lifting/carrying portions and an impact resistant tough outer shell to the container body.

In the example of FIG. 1, the tool container 10 comprises a body 12 and a closable lid 14. The lid comprises a plurality of hooks 16, the hooks 16 being coupled to an inner surface c the lid 14 and being arranged to be releasably engagable with a rail, such as the rail of the EWP In this way, when the lid is in an open configuration, the hooks 16 can be engaged with an uppermost rail of the EWP such that the tool container 10 hangs from the uppermost EWP rail at a height above the floor of the EWP.

In this example, each hook 16 comprises a curved portion 18 that curves towards the inner surface of the lid 14 such that a distance between an end of the curved portion 18 and the inner surface of the lid 14 is less than a diameter of the rail. The curved portion I 8 can be moved away from the inner surface of the lid 14 to facilitate engagement of the hooks 16 with the rail, the rail being received at region 20 of each hook 16. After the rail is received at the region 20, the curved portion 18 can return to the position shown in FIG. 1 so as to assist in retaining the rail at the region 20. The curved portions 18 may be arranged to return to the position shown in FIG. 1 by virtue of the material used, for example by using a resilient material.

The lid 14 is coupled to the body 12 via a hinge 22. In this example, the hinge 22 is a piano hinge, and supports the tool container 10 when the tool container 10 is fully loaded with tools, other pieces of work equipment and personal items when the hooks 16 are engaged with a rail of the EWP and the tool container 10 is hanging from the rail.

The lid 14 is movable between an open configuration which facilitates items being received within, and removed from, an internal portion 24 of the body 12, and a closed configuration for preventing removal of items from the internal portion 24. The lid 14 comprises a flap 26 that, when the lid is in the closed configuration, overlaps at least a portion of a front side 28 of the body 12. The overlapping flap 26 can assist in providing protection from weather and/or theft.

The overlapping flap 26 also provide the advantage of enabling the lid 14 to be retained in the closed configuration, in this example by providing an aperture 30 on the flap 26, the aperture 30 being arranged to receive a corresponding latch hole 32 arranged on the front side 28 of the body 12.

When the lid 14 is in the closed configuration, the flap 26 can be arranged to overlap an upper portion of the front side 28 and the aperture 30 can receive the latch hole 32. The lid 14 can be locked in the closed configuration by locking the latch hole 32, for example with a padlock. In this example, the aperture 30 and the latch hole 32 are steel reinforced to assist in preventing removal of the padlock by a thief, for example.

Providing a lid 14 that is moveable to a closed configuration and wherein the hooks 16 are coupled to the inner surface of the lid 14 provides an advantage whereby the hooks 16 are not exposed when the lid is in the closed configuration, for example when the tool container 10 is being transported or carried, thereby reducing a chance that the hooks 16 will be caught on pieces of equipment and other workers, for example, when the tool container 10 is being transported or carried.

The tool container 10 comprises a plurality of tool frogs 34 for receiving tools when the tools are not in use. In this example, the tool frogs 34 are arranged along a rear internal wall 36 of the body 12 although it will be appreciated that tool frogs 34 can be arranged at any appropriate location of the tool container 10, including at external locations, for example on the front surface 28 or on external side surfaces of the body 12. The tool frogs 34 may be arranged to receive particular types of tools. The tool frogs 34 may comprise inserts, for example flared plastic inserts, to facilitate receiving and retaining particular tools.

The tool container 10 also comprises a plurality of job lock key holders 38 for holding job lock keys that are used for locking functions, such as a movement operations, of EWPs or other equipment used in respect of particular jobs. The job lock key holders 38 are, in this example, arranged along internal side walls of the body 12.

The tool container 10 also comprises a sleeve 40 for receiving job tags or similar, the sleeve 40 being arranged on the front surface 28 of the body 12.

The tool container 10 also comprises a pouch 42 for receiving personal items, the pouch 42 being arranged on a front internal wall of the body 12.

The tool container 10 is arranged so as to support at least a portion of a user's weight. In this way, the tool container 10 can be used to sit on during work breaks, for example. In this example, a portion 44 of the lid 14 not including the flap 26 is formed from aluminium or a rigid plastic, for example, to assist in supporting the user's weight.

Further, the tool container 10 comprises a rigid frame 46, represented as dashed lines in FIG. 1, which assists in strengthening the tool container 10 for supporting at least a portion of the user's weight. In this example, the frame 46 is formed from aluminium or steel or another appropriate metal 46. The rest of the ‘body 12 comprises a suitable lightweight polymer such that the combination of frame 46 and polymer material provides a tool container 10 that has relatively good structural strength without being too heavy.

In this example, the frame 46 comprises a front and rear support bar 60, 62 and side support bars 64. The support bars 60, 62, 64 extend from a lower end of the tool container 10 to an upper end of the tool container 10. The frame 46 also comprises upper and lower support portions 66, 68, the support portions 66, 68 extending along a perimeter of the tool container 10. The support portions 66, 68 are coupled to the support bars 60, 62, 64 so as to form the frame 46.

The frame 46 may also reinforce the tool frogs 34, for example if portions of the frame 46, such as the front and rear support bars 60 62, coincide with locations of the tool frogs 34.

The tool container 10 also comprises metal D-rings 48 for facilitating lifting of the tool container 10, for example by attachment to lifting chains 50 (see FIG. 3) of a crane or other lifting apparatus. In this way the tool container 10, which may be relatively heavy when fully loaded with tools, can be lifted to an EWP or other elevated location of work or work platform by means of the lifting apparatus. In this example, the D-rings 48 are coupled to the body 12 via metal couplings 52, the couplings 52 being integral with the frame 46 so as to reinforce the coupling between the body 12 and the D-rings 48. In this particular example, the D-rings 48 are coupled to the side support bars 64.

The D-rings 48 and the metal couplings 52 are offset from the body 12 so as to facilitate closing of the lid 14. In one embodiment, the D-rings 48 and the metal couplings 52 are arranged further towards the rear wall 36 of the body 12 than the front surface 28 so as to assist in maintaining stability of the tool container 10 when the tool container 10 is loaded with tools in tool frogs 34 arranged along the rear wall 36.

The tool container 10 also comprises shoulder straps 54 and a chest strap 56 that are arranged to facilitate lifting of the tool container 10 by a user, for example such that the tool container 10 can be carried on a user's back.

The tool container 10 also comprises padding 58 at a lower region of the tool container so as to provide additional comfort to a user when the user is carrying the tool container 10 on the user's back.

Having described preferred embodiments of the invention with reference to the accompanying drawings, it is to be understood that the invention is not limited to those precise embodiments and that various changes and modifications could be effected therein by one skilled in the art without departing from the spirit or scope of the invention as defined in the appended claims.

For example, it will be appreciated that the hooks 16, or indeed any other portion of the tool container 10 that is arranged to be releasably engagable with a rail, such as a rail of an EWP, do not necessarily have to be arranged on an internal surface of the lid 14, and can be arranged at any appropriate location or portion of the tool container 10 so as to facilitate engaging the tool container 10 with the rail.

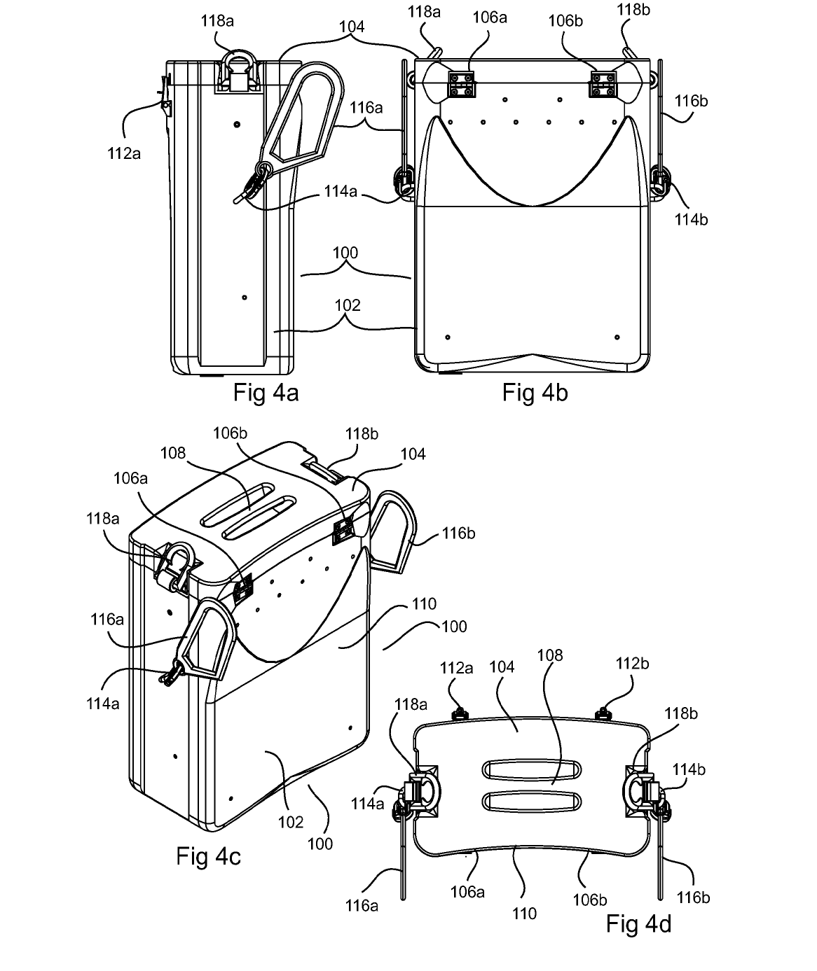

FIGS. 4a to 4d show side, rear, perspective and top views of an alternative embodiment of a tool container 100 of the present invention.

The tool container 100 in this embodiment has a body portion 102, and a lid portion 104 attached to the body portion via hinges 106a106b. Although the hinges are shown external to the body and lid, it will be appreciated that they can be mounted internally thereof.

The lid portion includes a handle 108, which is preferably moulded into a polymer material forming the lid, such as ABS plastic, polypropylene, polycarbonate or PVC. Alternatively the handle can be a discrete member separately attached to the lid portion, such as a polymer or metal handle riveted to a polymer or metal lid portion.

It will be noted that this embodiment has a curved shape to the rear face 110 to the body portion. This curvature is best shown in the perspective view FIG. 4c and top view FIG. 4d. The curved form provides additional comfort to a person carrying the tool container on their back. Padding can be provided on shoulder straps (not shown) and applied to the rear face 110.

Clasps 112a,112b are used to retain the lid portion closed. Release of the clasps allows the lid portion to be hingedly opened for access into the body portion of the container.

Rings 114a,114b are provided at respective sides of the container body. The rings project from the body portion and provide for attachment of lifting/carrying hooks 116a,116b. The lifting/carrying hooks can be double action scaffold hooks.

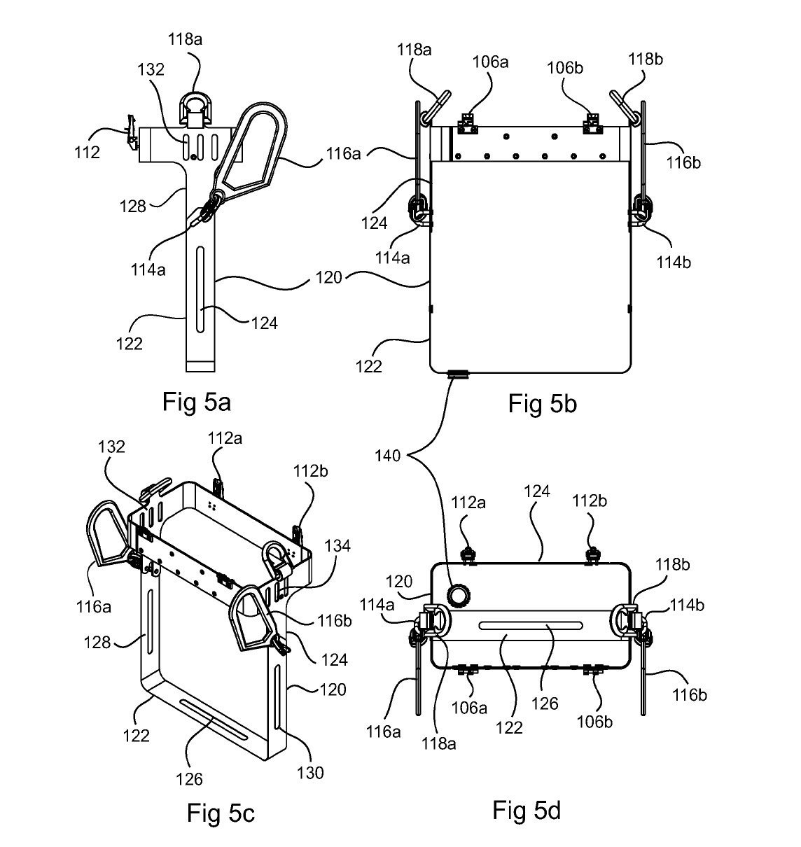

FIGS. 5a to 5b show respective side, rear, perspective and top views of an internal support structure 120 for the tool container 110 of FIGS. 4a to 4d.

The support structure is provided in the form of a frame comprising a lower strap 122 attached to an upper band 124. Preferably the lower strap and upper band are attached where the rings 114a,114b are provided. Thus, the attachment of the rings to/through the body of the container can be used to also connect the lower strap and upper band together, such as by riveting.

Rings 118a,118b are provided attached to the upper portion of the upper band 124. These rings can be used as alternative or additional lifting points, and can be used to secure the container to a EWP or other raised platform etc.

The lower strap and upper band are provided with slots 126,128,130,132,134 for attachment of the support structure to the inside of the container body. For example, rivets, screws or bolts may be used to connect through the material of the wall9s) of the container body into the slots and thereby connect the support structure and body together.

A drain plug 140 can be provided in the base of the tool container. This allows moisture to be drained in the event that the container has liquid in it, such as rainwater or spilled liquid. A Representation of the drain plug and its position relative to the support structure/frame is shown in FIGS. 5b and 5d. The drain plug can be screw threaded to undo to release liquid or draining the container after washing out.

It will be appreciated that lifting or carrying of the tool container by the carrying hooks transfers forces through the support structure to prevent damage to the container body. Loads on the lifting points, such as the rings and carrying hooks are transferred through the support structure and not directly from the lifting points into the material of the container body.

The hinges 106a,106b and clasps 112a,112b are mounted to the support structure for added strength and integrity of the tool container.

It will be appreciated that the support structure provides a frame that is inserted into the container body or the container body is formed around the frame. In one embodiment the container body portion can be moulded around the frame.

Preferably the support structure is formed of stainless steel, though mild steel or aluminium can be used in lower strength applications.

In the claims which follow and in the preceding description of the invention, except where the context requires otherwise due to express language or necessary implication, the word ‘comprise’ or variations such as ‘comprises’ or ‘comprising’ is used in an inclusive sense, i.e. to specify the presence of the stated features but not to preclude the presence or addition of further features in various embodiments of the invention.

1-28. (canceled)

29. A tool container comprising at least one tool receiving portion arranged for receiving a tool; and a rail engaging portion arranged so as to be releasably engageable with a rail.

30. The tool container of claim 29, wherein the rail engaging portion is arranged so as to be releasably engagable with a rail of an elevating work platform (EWP).

31. The tool container of claim 30, wherein the rail engaging portion is located on an inner surface of a closable lid portion such that the rail engaging portion is exposed and able to be engaged with the rail when the lid portion is open.

32. The tool container of claim 29, wherein the tool container comprises a plurality of tool holders, at least one tool holder being arranged within the tool receiving portion and a further tool holder being arranged on the external surface of the tool container.

33. The tool container of claim 29, wherein the tool container comprises at least one job lock key holder for holding a job lock key.

34. The tool container of claim 29, the tool container comprises a portion for receiving personal items, wherein the portion for receiving personal items includes a pouch, the pouch being located within the tool receiving portion of the tool container.

35. The tool container of claim 29, wherein the tool container comprises a closable lid portion and a lid receiving portion, the lid portion and the lid receiving portion being arranged such that the lid portion can be retained in the closed position.

36. The tool container of claim 35, wherein the Lid portion and/or the lid receiving portion is/are arranged such that the tool container is lockable in the closed configuration.

37. The tool container of claim 36, wherein the lid portion comprises an aperture for receiving a latch hole of the tool container.

38. The tool container of claim 37, wherein the latch hole is arranged so as to receive a padlock or similar.

39. The tool container of claim 29, including a container body portion supported on a support structure substantially internal of the body portion or material of the body portion.

40. The tool container of claim 39, wherein the support structure includes a frame.

41. The tool container of claim 39, wherein the support structure includes at least one lower strap attached to a base of the body portion and at least one upper band attached to the body portion adjacent an opening thereof into the body portion.

42. The tool container of claim 39, wherein the support structure is formed of one of or a combination of two or more of stainless steel, mild steel and aluminium.

43. The tool container of claim 29, wherein lifting or carrying hooks are provided as double action hooks.

44. The tool container of claim 29, wherein the tool container comprises at one carrying portion for facilitating lifting of the container.

45. The tool container of claim 44, wherein the at least one carrying portion, or a further carrying portion, is arranged so as to facilitate lifting of the container by a user.

46. The tool container of claim 45, wherein the carrying portion comprises at least one strap arranged such that the user can carry the tool container in a manner similar to a backpack.

47. The tool container of claim 29, wherein the tool container comprises a substantially rigid frame that is configured so as to support at least a portion of the user's weight.

48. The tool container of claim 29, wherein the tool container includes a reinforcing structure incorporating at least one support that extends from a lower end of the tool container to an upper end of the tool container.
